(19) United States
(12) Patent Application Publication
(10) Pub. No.: US 2016/0335631 A1
(43) Pub. Date: Nov. 17, 2016

(54) METHOD AND SYSTEM OF SELF-IMPOSING A FINANCIAL PENALTY FOR PURCHASING COMESTIBLES CONTAINING NUTRITIONAL CONTENT NOT IN COMPLIANCE WITH USER PRE-DEFINED NUTRITIONAL CONTENT GUIDELINES

(71) Applicant: MasterCard International Incorporated, Purchase, NY (US)

(72) Inventor: JUSTIN XAVIER HOWE, San Francisco, CA (US)

(21) Appl. No.: 14/712,592

(22) Filed: May 14, 2015

(51) Int. Cl. G06Q 20/40; G06Q 20/10

(52) U.S. Cl. CPC G06Q 20/405; G06Q 20/10

(57) ABSTRACT

A system and method are provided herein for self-imposing a financial penalty for purchasing comestibles containing nutritional content not in compliance with user pre-defined nutritional content guidelines. One or more user pre-defined nutritional content guidelines and one or more user pre-defined target accounts are stored and associated with one or more financial transaction instruments of the user. Financial transactions based on the one or more financial transaction instruments are monitored to identify comestibles purchased by the user. If the nutritional content of at least one of the purchased comestibles is not in compliance with the guidelines, a financial transaction is initiated to transfer funds against the one or more financial transaction instruments in favor of the one or more target accounts. Advantageously, the method and system of the subject disclosure allows for a user to self-impose a financial incentive to abide by self-defined nutritional guidelines.

### FIELD OF THE DISCLOSURE

The disclosure herein relates to payment-network-based, self-imposed systems and methods for incentivizing good eating habits.

### BACKGROUND OF THE DISCLOSURE

Various methods and systems exist in the prior art intended to improve eating habits. For example, smart phone applications exist, such as, “MyFitnessPal's Calorie Counter and Diet Tracker” which allows for a user to log meals with the application tracking the calorie content thereof. Tracking of other nutritional values and particular products or ingredients, such as caffeine, are also known in the prior art. These, however, all appear to require some manual entry for tracking.

### SUMMARY OF THE DISCLOSURE

A system and method are provided herein for self-imposing a financial penalty for purchasing comestibles containing nutritional content not in compliance with user pre-defined nutritional content guidelines. One or more user pre-defined nutritional content guidelines and one or more user pre-defined target accounts are stored in an electronic memory and associated with one or more financial transaction instruments of the user. Financial transactions conducted over one or more payment networks based on the one or more financial transaction instruments are monitored to identify comestibles purchased by the user. The nutritional content of the purchased comestibles is determined and compared with the guidelines. If the nutritional content of at least one of the purchased comestibles is not in compliance with the guidelines, a financial transaction is initiated by electronically transmitting an authorization request to transfer funds against the one or more financial transaction instruments in favor of the one or more target accounts. Advantageously, the method and system of the subject disclosure, allows for a user to self-impose a financial incentive to abide by self-defined nutritional guidelines.

These and other features of the disclosure will be better understood through a study of the following detailed description and accompanying drawings.

### BRIEF DESCRIPTION OF THE DRAWINGS

FIG. 1 is a schematic of a system useable with the subject disclosure;

FIG. 2 is a schematic of an account configuration useable with the subject disclosure; and,

FIG. 3 is a flow chart in accordance with the subject disclosure.

### DETAILED DESCRIPTION OF THE DISCLOSURE

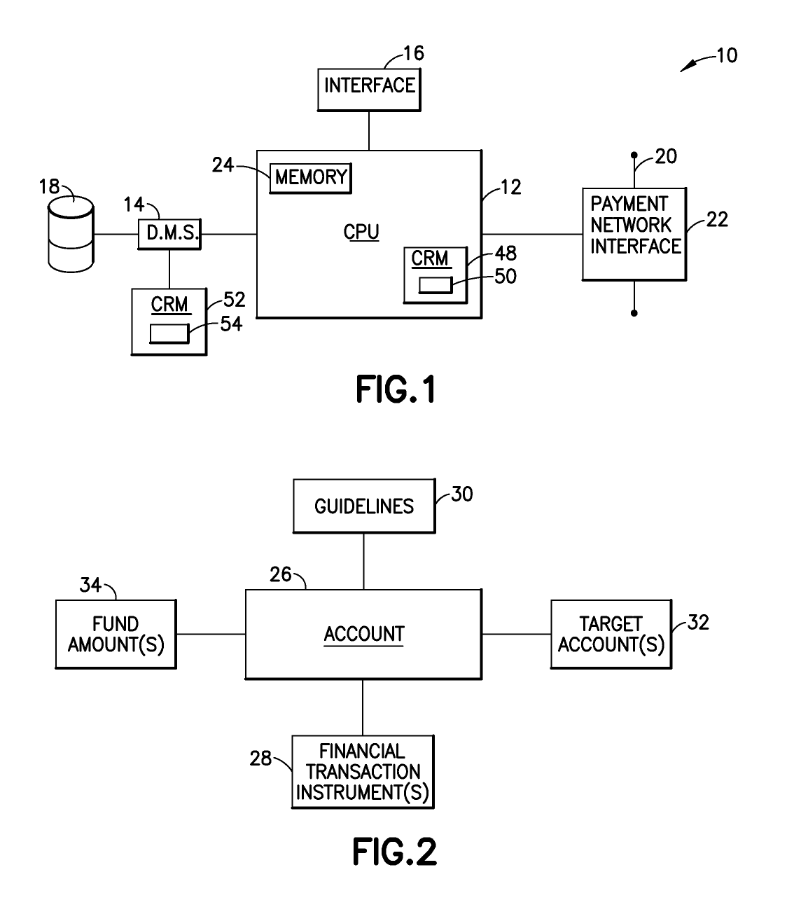

With reference to FIG. 1, a system 10 is shown useable for allowing users to self-impose a financial penalty for purchasing comestibles containing nutritional content not in compliance with user pre-defined nutritional content guidelines. The system 10 generally includes a central processing unit (CPU) 12 and a database management system 14.

The CPU 12 may be located on one or more computing devices found either at one location or operatively linked over a network. The CPU 12 may be specialized, e.g., a dedicated device, configured to practice the subject disclosure. The CPU 12 may include an interface 16 to allow interaction with a user. The interface 16 may be a graphical user interface (GUI), a communications port and/or a wireless receiver. In addition, the interface 16 may include any known configuration for inputting data, such as a touch screen, keyboard, mouse and so forth. The interface 16 may be also configured to transmit data, including by display, e.g., being a graphical user interface (GUI), a communications port or a wireless transmitter. As will be recognized by those skilled in the art, the interface 16 may be configured to be both a receiver and a transmitter.

The database management system 14 may be of any electronic, non-transitory form configured to interact with database 18. The database management system 14 is operatively linked with the CPU 12, and may reside on the same or different computing device from the CPU 12. The database management system 14 may include MySQL, MariaDB, PostgreSQL, SQLite, Microsoft SQL Server, Oracle, SAP HANA, dBASE, FoxPro, IBM DB2, LibreOffice Base, FileMaker Pro, Microsoft Access and InterSystems Caché.

The database 18 may be of any electronic, non-transitory form which may be managed by the database management system 14. The database 18 has stored therein data structures corresponding to nutritional content of various comestibles. The nutritional content may include quantities of various nutritional characteristics for each of the comestibles, including, but not limited to, calories, fat, carbohydrates, sodium, sugar, and so forth. These characteristics may be stored on a per-serving basis of the comestibles and/or as total values for different sized products of the comestibles. The database 18 may also include a listing of beneficial food ingredients for each of the comestibles, such as vitamins, elements and proteins; and, the database 18 may also include a listing of nutritionally-undesirable ingredients for each of the comestibles, such as, bleached flour, trans fats, artificial sweeteners, and so forth. The various ingredients (beneficial and/or nutritionally-undesirable) may be listed as being present and/or listed with corresponding quantities.

The database 18 may be located on one or more computing devices which are operatively linked with the database management system 14, including residing on the same computing device as the database management system 14.

The CPU 12 is configured to monitor financial transactions conducted over one or more payment networks 20. Each of the payment networks 20 is a network of specialized computing devices which are operatively linked (hard-wired, wirelessly, etc.) to allow for secure transmission of financial transaction details between various entities (issuers, acquirers, banks, etc.) to facilitate authorization, clearing and settlement of financial transactions. The payment networks 20 are restricted and not freely publicly accessible.

The financial transactions may be presented to the CPU 12 in batch form, for example periodically post-settlement. In addition, or alternatively, a payment network interface 22 may be utilized which allows the CPU 12 access to the one or more payment networks 20 so as to review financial transactions thereon while being processed. The financial transactions may be caused to pass through the CPU 12 by the payment network interface 22 which intercepts the financial transactions and once again releases the financial transactions once processed through the CPU 12.

The CPU 12 is configured to monitor the financial transactions to identify purchased comestibles. The comestibles may be identified using various techniques. For example, as set forth in ISO 8583, information is communicated across payment networks 20 using standard message formatting. It is taken that the financial transactions referenced herein are in standard message formatting, e.g., in accordance with ISO 8583, with various components of the payment networks 20 being configured to process financial transactions prepared with standard message formatting. With standard message formatting, particular data elements are included which relate to the respective financial transaction, including merchant category, merchant name, SKU or other product identifiers of purchased items. The product identifiers may be included in standard data elements and/or in optionally-used data elements, e.g., as Level III data. The CPU 12 may be configured to extract product identifiers from the data elements of the financial transactions and reference a source, such as a database, or issue an inquiry to a source, to identify whether particular products are comestibles. The database 18 may be utilized via the database management system 14 to identify products as comestibles. In addition, or alternatively, product classification codes, e.g., Global Product Classification (GPC) codes, may be referenced in the data elements of the financial transactions, e.g., by being extracted by the CPU 12, to determine if a product is classified under a food-related classification. The CPU 12 may avoid the need to reference an external source where product classification codes are present. A locally-stored look-up table or database with data structures including cross-referenced product descriptions and product classification codes may be utilized, e.g., stored in electronic memory 24.

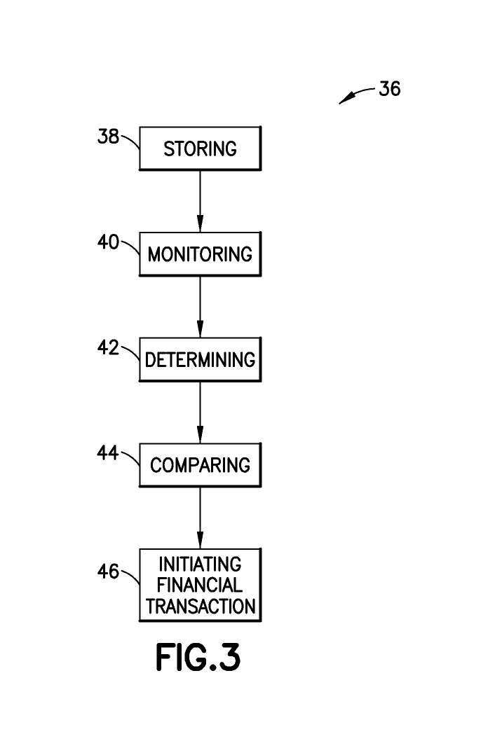

The CPU 12 is associated with an electronic memory 24 in which users may store pre-defined nutritional content guidelines and pre-defined target accounts, e.g., in account form. The users may utilize the interface 16 to enter such data. Preferably, as shown in FIG. 2, accounts 26 are established for each of the users of the system 10 associated with one or more financial transaction instruments 28 of the users. The financial transaction instruments are configured to conduct financial transactions over one or more of the payment networks 20, such as credit or debit transactions, and may be in any known form, including, but not limited to, a readable card, such as with a readable magnetic strip or integrated circuit chip (e.g., EMV chip), a NFC (near field communication) device, such as a fob or other wirelessly-communicating device which causes activation through proximity or other wireless communication, a program or application on a smart phone or other computer device, and/or a manually-entered or stored account or other identification number. A user, through their respective account 26, associates pre-defined nutritional content guidelines 30 and one or more pre-defined target accounts 32 with their respective account 26. The user may define all or some of the guidelines 30 and/or adopt, wholly or partially, predetermined guidelines, e.g., stored in the CPU 12. Also, through their respective account 26, the user pre-defines amounts of funds 34 to be transferred to the one or more target accounts 32 as penalty for being non-compliant with his/her own pre-defined guidelines 30. In this manner, the user may define nutritionally desirable guidelines and self-impose a financial penalty where there is non-compliance therewith. With the subject disclosure, when a comestible is purchased using one or more of the financial transaction instruments 28, a transfer of funds is automatically initiated. An authorization request to transfer funds may be automatically initiated against one or more of the financial transaction instruments 28 in favor of one or more of the target accounts 32 in the pre-defined amount of funds 34. One or more secondary fund sources (e.g., bank accounts, brokerage accounts, etc.), other than the financial transaction instruments 28, may be associated with the accounts 26 from which funds may be transferred. It is also possible that a financial institution or other enterprise may be specified as a source of the transfer of funds with the financial institution or enterprise billing or otherwise seeking to collect payment from the user. The authorization request may be a payment network based authorization request (e.g., credit or DDA transaction) and/or an electronic communication configured to be sent and received with instructions. The authorization request, at a minimum, includes a specified amount of funds and a target account for those funds. It is to be understood that a plurality of authorization requests may be generated to satisfy a financial penalty, particularly where funds are specified to be transferred to more than one target account and/or one or more source of funds is specified.

The target accounts 32 may be charities and/or self-beneficial accounts, such as a user's mortgage account, home equity line of credit, loan, and so forth. The pre-defined amount of funds 34 may be varied to correspond to different acts of non-compliance. For example, a purchased comestible having a calorie amount above a pre-defined amount in the guidelines 30 along with the presence of an undesirable ingredient specified in the guidelines 30, e.g., an artificial sweetener, may be defined to cause a higher amount of retribution, i.e., payment of funds, than a less-egregious purchased comestible, e.g., which may have a fat content slightly above a pre-defined amount in the guidelines 30. Likewise, the financial transaction instruments 28 and the target accounts 32 may be varied in similar fashion.

FIG. 3 shows a method 36 useable to allow a user to self-impose a financial penalty for purchasing comestibles containing nutritional content not in compliance with user pre-defined nutritional content guidelines. In a first step 38, a user stores one or more pre-defined nutritional content guidelines 30 and one or more pre-defined target accounts 32 on the electronic memory 24, e.g., associated with an account 26. The guidelines 30 and the one or more target accounts 32 are associated with one or more financial transaction instruments 28 of the user. The guidelines 30 may include defined threshold amounts of certain nutritional characteristics or ingredients. The threshold amount may be specified as 0%, whereby the mere presence of that characteristic or ingredient causes a breach of the guidelines 30. Also, the guidelines 30 may specify that below threshold, e.g., where a nutritionally-beneficial ingredient is specified, causes a breach of the guidelines 30 and/or that above threshold, e.g., where there is excess beyond a desired amount or presence of a characteristic or ingredient, constitutes a breach of the guidelines 30. The guidelines 30 may also specify that the mere presence of certain characteristics or ingredients causes a breach of the guidelines 30.

In a second step 40, financial transactions conducted over one or more of the payment networks 20 based on the one or more financial transaction instruments 28 are monitored by the CPU 12 to identify comestibles purchased by the user as described above. The CPU 12 associates purchased comestibles with users through associating the one or more financial transaction instruments 28 related to the financial transactions with the details of the accounts 26.

In a third step 42, once comestibles have been identified as being purchased by the user, the nutritional content of those purchased comestibles is determined. The database management system 14 may reference the database 18 for the nutritional content of the purchased comestibles. Any extracted product identifier may be used, and compared with, data structures of the database 18 to identify such nutritional content.

In a fourth step 44, the nutritional content of the purchased comestibles is compared, e.g., by the CPU 12, with the user's pre-defined nutritional content guidelines 30. If it is found that the nutritional content of the purchased comestibles is not in compliance with the guidelines 30, a fifth step 46 is conducted whereby a financial transaction is initiated to request to transfer funds against the one or more financial transaction instruments 28 in favor of the one or more target accounts 32 in the pre-defined amount 34. The financial transaction may be initiated by electronically transmitting an authorization request from the CPU 12 via the payment network interface 22 and onto the one or more payment networks 20. Such an authorization request, depending on proper settlement, will culminate in the transfer of funds against the one or more financial transaction instruments 28 in favor of the one or more target accounts 32. The transfer of funds may be of any known financial transaction type, including being a debit, credit charge and/or an electronic funds transfer. In this manner, the purchase of a comestible which is non-compliant with the user's pre-defined guidelines 30 shall result in automatic financial penalty of a transfer of funds to a beneficial cause.

In accordance with various embodiments of the present disclosure, the methods and system described herein are intended for operation as software programs running on a computer processor. Furthermore, software implementations can include, but are not limited to, distributed processing or component/object distributed processing, parallel processing, or virtual machine processing can also be constructed to implement the methods described herein.

The present embodiment contemplates at least one machine-readable medium or computer-readable medium (CRM) 48 containing instructions 50, or that which receives and executes instructions 50 from a propagated signal, so that the CPU 12 may operate as described herein using the instructions 50. In addition, at least one machine-readable medium or computer readable medium (CRM) 52 containing instructions 54, or that which receives instructions 54 from a propagated signal, so that the database management system 14 may operate as described herein using the instructions 54. The machine-readable medium or computer readable medium 48, 52 may be provided as one medium with the instructions 50, 54 located thereon.

While the machine-readable medium 48, 52 is shown in an example embodiment to be each a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform anyone or more the of the methodologies of the present embodiment. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives considered to be a distribution medium equivalent to a tangible storage medium. Accordingly, the embodiment is considered to include anyone or more of a tangible machine-readable medium or a tangible distribution medium, as listed herein and including art-recognized equivalents and successor media, in which the software implementations herein are stored.

Although the present specification describes components and functions implemented in the embodiments with reference to particular standards and protocols, the disclosed embodiments are not to limited to such standards and protocols.

What is claimed is:

1. A method of self-imposing a financial penalty for purchasing comestibles containing nutritional content not in compliance with user pre-defined nutritional content guidelines, said method comprising:
storing in an electronic memory one or more user pre-defined nutritional content guidelines and one or more user pre-defined target accounts, the guidelines and the one or more target accounts being associated with one or more financial transaction instruments of the user;
monitoring financial transactions conducted over one or more payment networks based on the one or more financial transaction instruments to identify comestibles purchased by the user;
determining nutritional content of the purchased comestibles; and,
comparing the nutritional content of the purchased comestibles with the guidelines,
wherein, if the nutritional content of at least one of the purchased comestibles is not in compliance with the guidelines, initiating a financial transaction by electronically transmitting an authorization request to transfer funds in favor of the one or more target accounts.

2. A method as in claim 1, wherein the authorization request to transfer funds is against the one or more financial transaction instruments.

3. A method as in claim 1, wherein the amount of the funds to be transferred is pre-defined by the user.

4. A method as in claim 1, wherein the step of determining the nutritional content of the purchased comestibles includes comparing product identifiers of the purchased comestibles with data structures maintained in a database of nutritional content of comestibles.

5. A method as in claim 4, wherein the product identifiers of the purchased comestibles are determined from data transmitted with the financial transactions over the one or more payment networks.

6. A system for self-imposing a financial penalty for purchasing comestibles containing nutritional content not in compliance with user pre-defined nutritional content guidelines, the system comprising;
CPU;
non-transitory, machine-readable storage medium, storing thereon first instructions which, when executed by the CPU, cause the CPU to
monitor financial transactions conducted over one or more payment networks to identify comestibles purchased by a user;
database management system; and
non-transitory, machine-readable storage medium, storing thereon second instructions which, when executed by the database management system, cause the database management system to
determine nutritional content of the purchased comestibles.

7. A system as in claim 6, wherein the first instructions further include instructions which, when executed by the CPU, cause the CPU to
compare the nutritional content of the purchased comestibles with user pre-defined nutritional content guidelines.

8. A system as in claim 7, wherein the first instructions further include instructions which, when executed by the CPU, cause the CPU to
initiate a financial transaction if the nutritional content of at least one of the purchased comestibles is not in compliance with the guidelines.

9. A system as in claim 7, further comprising an electronic memory for storing the guidelines.

10. A system as in claim 6, further comprising an interface configured to interface with one or more payment networks.

11. A system as in claim 10, wherein the CPU monitors the financial transactions via the interface.

12. A system as in claim 6, wherein the database management system determines the nutritional content of the purchased comestibles by comparing products identifiers of the purchased comestibles with data structures maintained in a database of nutritional content of comestibles.

13. A system as in claim 12, wherein the product identifiers of the purchased comestibles are determined from data transmitted with the financial transactions over the one or more payment networks.

14. A system as in claim 6, wherein the first and second instructions are located on the same non-transitory, machine-readable storage medium.
